(19) United States
(12) Patent Application Publication
(10) Pub. No.: US 2024/0210923 A1
(43) Pub. Date: Jun. 27, 2024

(54) SYSTEMS AND METHODS FOR QUANTUM SCHEDULING OPTIMIZATION

(71) Applicant: Honeywell International Inc., Charlotte, NC (US)

(72) Inventors: Bart Wilhelmus HOORN, Hilversum (NL); Elies ABDELMALEK, Dubai (AE); Stavros CHRYSANTHOU, Dubai (AE)

(21) Appl. No.: 18/145,092

(22) Filed: Dec. 22, 2022

(51) Int. Cl. G05B 19/418; G06N 10/40

(52) U.S. Cl. CPC G05B 19/41865; G06N 10/40; G05B 2219/34379

(57) ABSTRACT

Disclosed are methods and systems for process scheduling. A method may include, for example, obtaining, by a device including at least one quantum processing unit, a set of operations data for an industrial facility; generating, by the device, an optimization model based on the set of operations data; calculating, by the device using the at least one quantum processing unit and the optimization model, a set of solution values; and transmitting the set of solution values to a scheduling device configured to generate a process schedule for the industrial facility.

### TECHNICAL FIELD

Various embodiments of the present disclosure relate generally to systems and methods for optimizing scheduling at an industrial facility and, more particularly, to systems and methods for optimizing scheduling using quantum processing technology.

### BACKGROUND

Complex operations, such as those of industrial facilities, may confront many uncertainties. To manage uncertainties, such facilities may utilize scheduling applications that may provide operations instructions to maximize facility profitability based on forecasted values. However, because of the complexity of these operations, traditional computer processing technology may be incapable of suitably performing such optimization calculations. As a result, industrial facilities may not be able to optimize operations sufficiently and/or frequently enough, leading to waste, late product deliveries, and consequently decreased profitability.

The present disclosure is directed to overcoming one or more of these above-referenced challenges.

### SUMMARY OF THE DISCLOSURE

According to certain aspects of the disclosure, systems and methods for optimizing scheduling at an industrial facility are described.

In one example, a computer-implemented method of process scheduling may include: obtaining, by a device including at least one quantum processing unit, a set of operations data for an industrial facility, the set of operations data including (1) input data for the industrial facility, (2) output data for the industrial facility, and (3) a plurality of operational constraints for the industrial facility; generating, by the device, an optimization model based on the set of operations data, wherein the optimization model may define a plurality of variables corresponding to operations of the industrial facility and wherein the plurality of variables includes one or more time-based variables; calculating, by the device using the at least one quantum processing unit and the optimization model, a set of solution values, wherein each of the set of solution values may correspond to one or more of the plurality of variables and wherein the set of solution values may include one or more combinations of time and duration data; and transmitting the set of solution values to a scheduling device configured to generate a process schedule for the industrial facility.

In another example, a non-transitory computer-readable storage medium may store program instructions that are computer-executable to implement operations including: obtaining a set of operations data for an industrial facility, the set of operations data including (1) input data for the industrial facility, (2) output data for the industrial facility, and (3) a plurality of operational constraints for the industrial facility; generating an optimization model based on the set of operations data, wherein the optimization model may define a plurality of variables corresponding to operations of the industrial facility and wherein the plurality of variables may include one or more time-based variables; causing at least one quantum processing unit to calculate, using the optimization model, a set of solution values, wherein each of the set of solution values may correspond to one or more of the plurality of variables and wherein the set of solution values may include one or more combinations of time and duration data; and transmitting the set of solution values to a scheduling device configured to generate a process schedule for the industrial facility.

In still another example, a system may include: one or more quantum processing units; one or more memories storing instructions; and one or more processors operatively connected to the one or more memories. The one or more processors may be configured to execute the instructions to: obtain a set of operations data for an industrial facility, the set of operations data including (1) input data for the industrial facility, (2) output data for the industrial facility, and (3) a plurality of operational constraints for the industrial facility; generate an optimization model based on the set of operations data, wherein the optimization model may define a plurality of variables corresponding to operations of the industrial facility and wherein the plurality of variables may include one or more time-based variables; cause the one or more quantum processing units to calculate, using the optimization model, a set of solution values, wherein each of the set of solution values may correspond to one or more of the plurality of variables and wherein the set of solution values may include one or more combinations of time and duration data; and transmit the set of solution values to a scheduling device configured to generate a process schedule for the industrial facility.

In some embodiments, the set of operations data for the industrial facility may be obtained from the scheduling device.

In some embodiments, the input data may include one or more quantities of input resources and one or more times of arrival to the industrial facility for the input resources; and wherein the output data may include one or more quantities of output products and one or more target delivery times for the output products.

In some embodiments, the operational constraints may include constraints corresponding to one or more of a maximum quantity of input resources that the industrial facility is capable of processing, a maximum speed of processing input resources by the industrial facility, and a maximum quantity of output products that the industrial facility is capable of storing.

In some embodiments, the set of solution values may include start time information and duration information for each of a plurality of processing tasks.

In some embodiments, the set of solution values, when used to generate the process schedule, may be configured to cause the industrial facility to yield the one or more quantities of output products by the one or more target delivery times.

In some embodiments, the industrial facility is an oil refinery, the input resources include crude oil, and the output products include refined oil products.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary networked computing system environment, according to one or more embodiments.

FIG. 2 depicts a flowchart of operations of an industrial facility, according to one or more embodiments.

FIG. 3 depicts a flowchart of operations of an industrial facility, according to one or more embodiments.

FIG. 4 depicts a flowchart of operations of an industrial facility, according to one or more embodiments.

FIG. 5 depicts an exemplary process schedule, according to one or more embodiments.

FIG. 6 depicts an exemplary process flow for optimizing scheduling at an industrial facility, according to one or more embodiments.

FIG. 7 depicts an exemplary method of optimizing scheduling at an industrial facility, according to one or more embodiments.

FIG. 8 depicts an exemplary method of optimizing scheduling at an industrial facility, according to one or more embodiments.

FIG. 9 depicts an exemplary process schedule, according to one or more embodiments.

FIG. 10 depicts an exemplary system that may execute techniques presented herein.

### DETAILED DESCRIPTION OF EMBODIMENTS

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Various embodiments of the present disclosure relate generally to systems and methods for optimizing scheduling at an industrial facility and, more particularly, to systems and methods for optimizing scheduling using quantum processing technology.

Industrial facilities may face many and frequent uncertainties relating to operations. For example, feedstock and product prices can vary significantly on a daily basis. Moreover, operations in modern integrated plants have become so complex that many dynamic conditions may be observed every hour. To manage these uncertainties, industrial facilities, such as refineries, may rely on planning and scheduling applications that may provide operations instructions to maximize facility profitability based on forecasted values for different variables (e.g., feedstock prices, product prices, etc).

However, in some cases such planning may be done only on a monthly basis or, at best, a weekly basis. As variability increases, however, monthly and weekly updates may be unable to enable optimal operations. As a result, industrial facilities may operate on sub-optimal parameters relative to the actual conditions. In some situations, simulation and/or manual scheduling updates may be used to further limit the impact of the variability. However, the optimization problems introduced by modern industrial facilities may be very complex to solve given the number of variables, the amount of linear and non-linear correlations between variables, and the various non-financial considerations (e.g., safety, customer quality specs to meet, inventory limitations, etc.) that are also critical to facility operation. In light of such complexity, traditional computer processing technology may be incapable of solving such optimization problems within reasonable timeframes and with reasonable degrees of accuracy.

With the emergence of quantum computing technology, such optimization problems may indeed be solved quickly, accurately, and with greater frequency. Using quantum computing, industrial facilities may optimize operations on a much more frequent basis, e.g. daily or hourly, to approach a more optimal production profile. By optimizing operations, industrial facilities may decrease waste, minimize late product deliveries, and consequently enhance profitability.

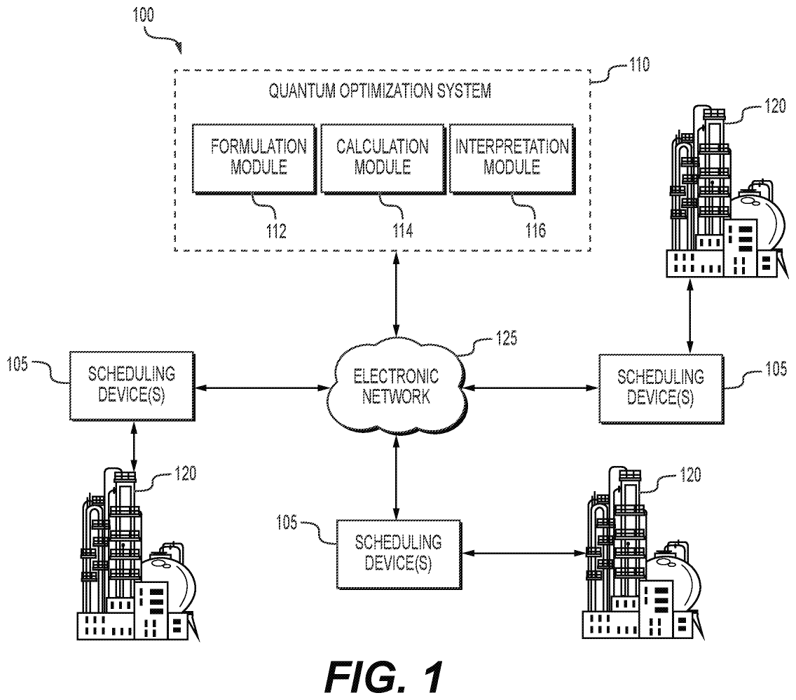

FIG. 1 illustrates an exemplary networked computing system environment 100, according to the present disclosure. As shown in FIG. 1, networked computing system environment 100 may include a quantum optimization system 110, one or more scheduling devices 105, one or more facilities 120, and an electronic network 125. As explained in greater detail hereinafter, components of networked computing system environment 100 may be in communication with each other via electronic network 125.

Quantum optimization system 110 of networked computing system environment 100 may be a computer system configured to perform optimization calculations. Quantum optimization system 110 may include one or more quantum processors and may further include one or more traditional processors. Quantum optimization system 110 may include formulation module 112, calculation module 114, and interpretation module 116. Formulation module 112 may be configured to formulate optimization problems. For example, based on operations data for an industrial facility, formulation module 112 may formulate an optimization model. The optimization model may define a plurality of variables corresponding to operations of the industrial facility. In some embodiments, the plurality of variables may include times and durations of operational tasks. Calculation module 114 may be configured to calculate solution values using an optimization model. For example, calculation module 114 may be implemented by the one or more quantum processors. Solution values calculated by calculation module 114 may correspond to variables defined by an optimization model. Interpretation module 116 may be configured to interpret and/or translate the output of calculation module 114.

Scheduling devices 105 may be computer system such as, for example, desktop computers, mobile devices, etc. In some embodiments, scheduling devices 105 may be cellphones, tablets, or the like. In some embodiments, scheduling devices 105 may include one or more electronic application(s), e.g., a program, plugin, browser extension, etc., installed in memory. In some embodiments, the electronic application(s) may be associated with one or more of the other components in the computing environment 100. For example, the electronic application(s) may include a web browser, another application, or the like configured to generate schedules for operations of an associated facility 120. As shown in FIG. 1, each scheduling device 105 may be associated with a facility 120. In some embodiments, each scheduling device 105 may be used to generate schedules for a respective facility 120.

Electronic network 125 may be any suitable network or combination of networks and may support any appropriate protocol suitable for communication of data to and from components in the networked computing system environment 100. Electronic network 125 may include a public network (e.g., the Internet), a private network (e.g., a network within an organization), or a combination of public and/or private networks. Electronic network 125 may be configured to provide communication between various components depicted in FIG. 1. Electronic network 125 may comprise one or more networks that connect devices and/or components in the network layout to allow communication between the devices and/or components. For example, the electronic network 125 may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, electronic network 125 may be implemented using cellular networks, satellite, licensed radio, or a combination of cellular, satellite, licensed radio, and/or unlicensed radio networks.

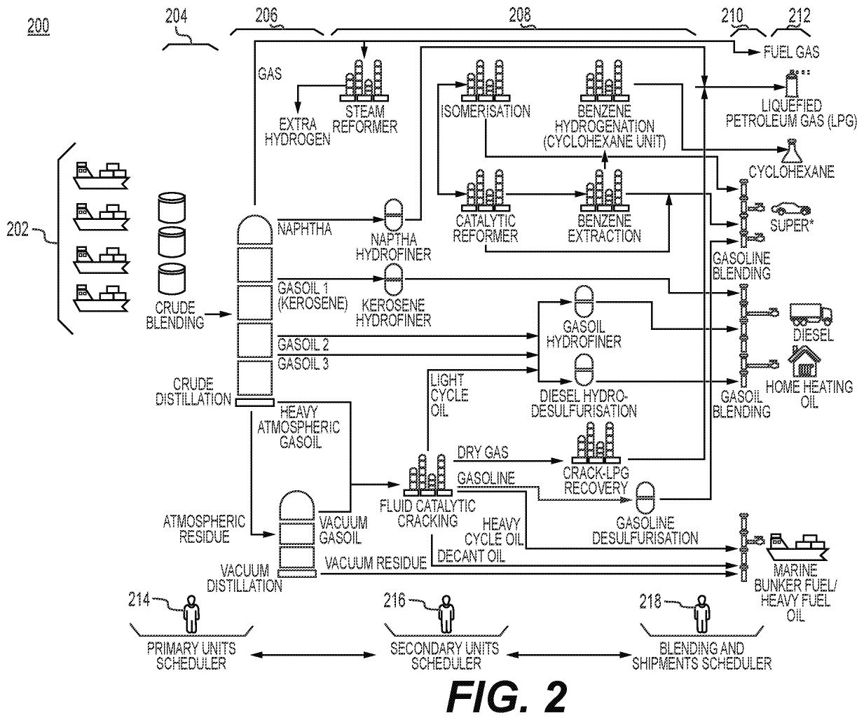

FIG. 2 depicts a flowchart 200 illustrating operations at an exemplary industrial facility. In some embodiments, the exemplary industrial facility may be an oil refinery, for example. As shown, there may be many different operational steps that must be managed and scheduled in order to convert crude oil to marketable end-user oil products useful for a variety of applications.

In some embodiments, the facility may receive a plurality of shipments 202 of crude oil, which may be referred to herein as inputs. Shipments 202 may then be transferred to a plurality of blending tanks 204 in which the crude oil may be blended. Following blending, the crude oil may transition to a distillation stage 206 occurring in a plurality of distillation tanks. From the distillation stage 206, the products may then proceed to an intermediate processing stage 208. Depending on what type of finished product is to be produced, intermediate processing stage 208 may include any or all of steam reformation, isomerization, catalytic reformation, benzene hydrogenation, benzene extraction, naphtha hydrofining, kerosene hydrofining, gasoil hydrofining, fluid catalytic cracking, crack-LPG recovery, gasoline desulfurization, or the like. Following distillation stage 206, the products may proceed to blending stage 210. At blending stage 210, different intermediate products may be blended together as necessary to form end-user oil products. The end-user oil products may then proceed to storage stage 212 where they are stored and prepared for delivery to customers.

Due to the quantity and complexity of operations shown in FIG. 2, multiple scheduling units may be used to coordinate and schedule the various operations. For example, a primary units scheduler 214 may be used to manage scheduling for shipments 202 and blending tanks 204, a secondary units scheduler 216 may be used to manage scheduling for distillation stage 206 and intermediate processing stage 208, and a blending and shipments scheduler 218 may be used to manage scheduling for blending stage 210 and storage stage 212.

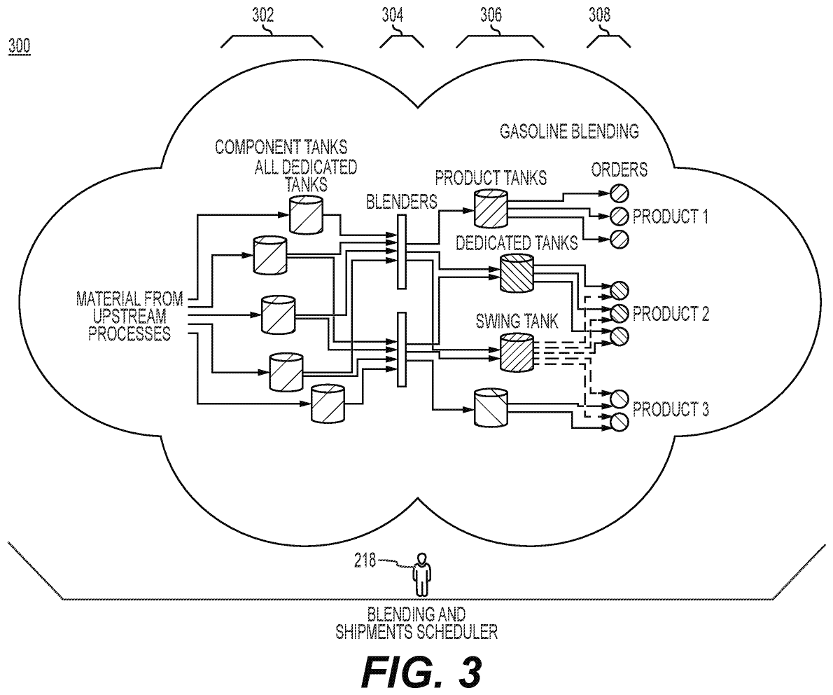

FIG. 3 depicts a flowchart 300 illustrating further complexities within the operations depicted in FIG. 2. Gasoline blending alone, for example, may include multiple steps and processes that may be managed and scheduled. As shown, material from upstream processes may proceed to one or more component tanks 302. From the one or more component tanks 302, the material may proceed to one or more blenders 304 at different times and in different combinations. For example, a first material may be blended with a second material in a blender during a first time slot, and a third material may be blended with a fourth material in that blender during a second time slot.

From one or more blenders 304, the blended material may proceed to one or more storage tanks 306 before ultimately being dispensed according to customer orders. Scheduling these operations may be handled by blending and shipments scheduler 218, as described previously with reference to FIG. 2.

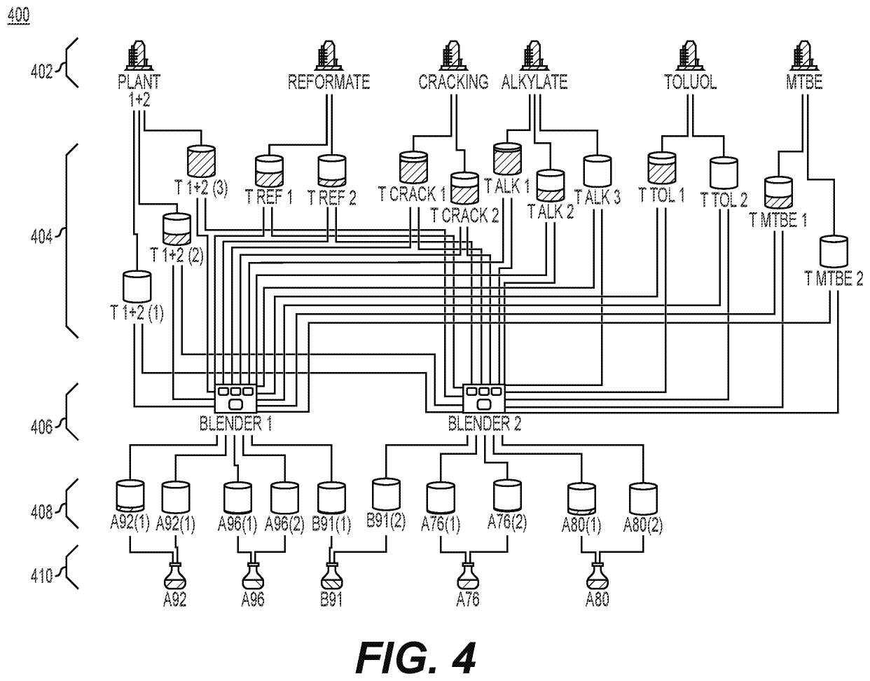

FIG. 4 depicts a flowchart 400 of still further complexities associated with product blending. As shown, materials may proceed from multiple sources 402. The materials may be stored in multiple component tanks 404, before proceeding to blenders 406 at different times and in different combinations. From the blenders 406, the blended material may proceed to multiple storage tanks 408 before being prepared according to customer orders.

The foregoing flowcharts illustrate the various complexities associated with industrial processes, including those involving conversion of a raw material (e.g., crude oil) to end user products in an industrial facility (e.g. a refinery). Absent scheduling, facility resources may be underutilized leading to waste. Even with scheduling using traditional computer processors, operations may be suboptimal.

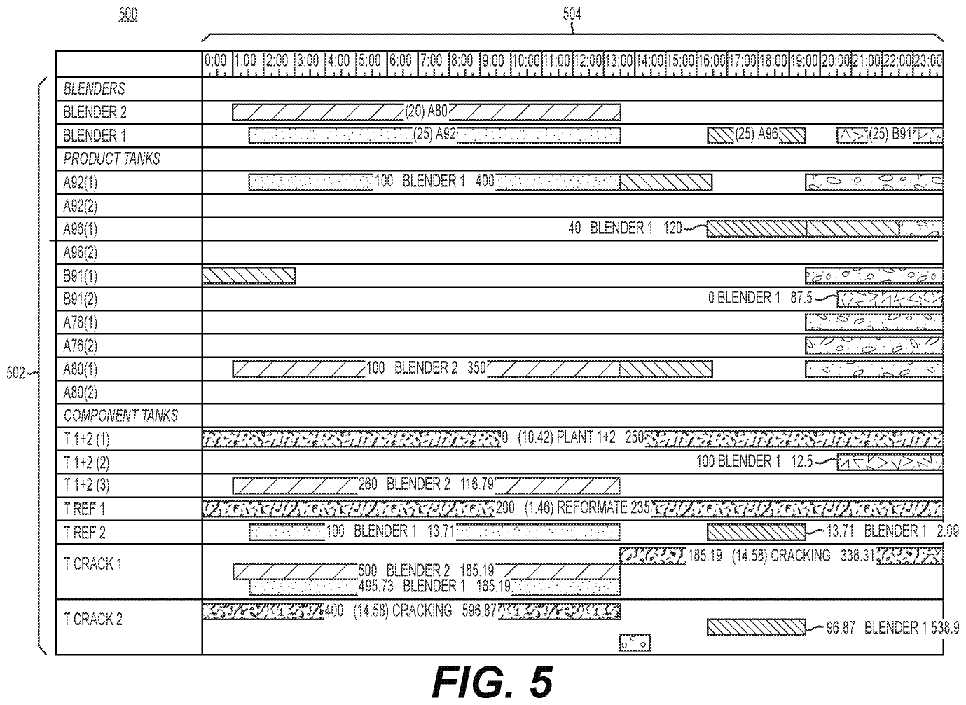

FIG. 5 depicts an exemplary schedule 500 for a refinery that may be suboptimal. Schedule 500 may include rows 502, wherein each row may be indicative of a component of the refinery. Components of the refinery may include blenders, product tanks, component tanks, or any other suitable components or equipment. Schedule 500 may further include time axis 504. By cross-referencing an item in schedule 500 to rows 502 and time axis 504, one may understand a scheduled time and duration for a given component and/or associated process step. A constraint of the particular refinery represented by schedule 500 may be that products must be blended and certified by 19:00 so as to be delivered to customers on time. If product is not delivered to a customer on time, contractual penalties may apply and consequently the refinery may suffer financial loss. Alternatively, or in addition, late products may become undeliverable and lead to waste.

As shown in schedule 500, blender 1 may be scheduled to blend product A96 from 16:00 to 19:00. As a result, product A96 may not be certified until 22:00, which is significantly later than the 19:00 deadline. This may lead to a penalty and/or financial loss. Similarly, blender 1 may be scheduled to blend product B91 beginning at 20:00. A timing of such blending may result in product B91 remaining in tank B91(2) into the following day and therefore becoming undeliverable. This may likewise result in financial loss due to waste. Such scheduling issues may be frequent when using scheduling applications that are limited by the computational capabilities of traditional processors.

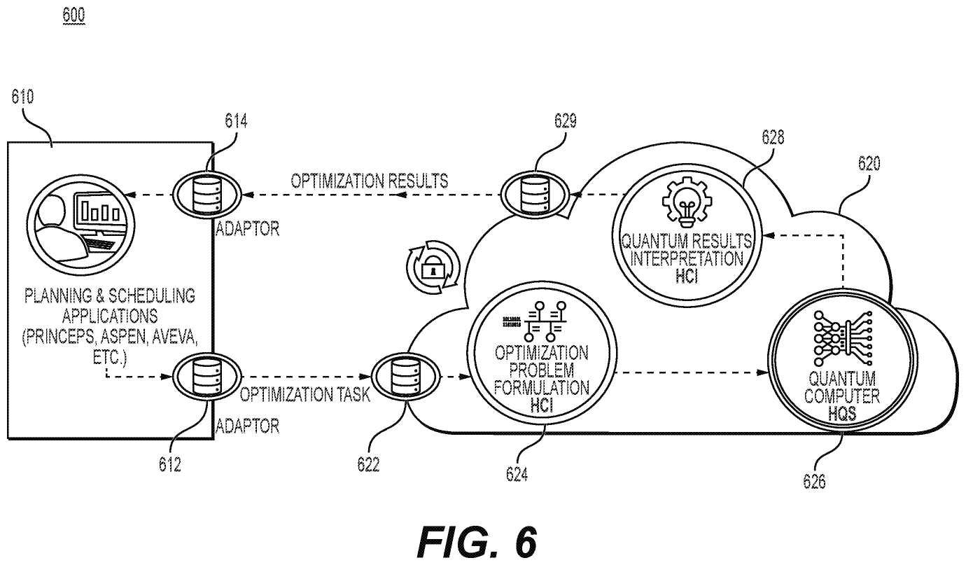

FIG. 6 depicts an exemplary process flow 600 in which quantum processing may be leveraged to address the aforementioned challenges. Exemplary process flow 600 may begin with one or more planning and/or scheduling applications 610 (hereinafter scheduling applications 610). In some embodiments, scheduling applications 610 may be used to manage the operations of an industrial facility such as the one or more facilities 120 described previously with reference to FIG. 1. For example, scheduling applications 610 may be used by personnel responsible for managing operations of industrial facilities to generate operations schedules. Scheduling applications 610 may ingest operations data for the industrial facility, including input data, output data, and/or operational constraints. The operations data may be manually entered by facility personnel, automatically detected by scheduling applications 610 based on sensor data, retrieved from a remote database, or any combination of the foregoing.

In some embodiments, the input data may include quantities of input resources and times of arrival to the industrial facility for the input resources. For example, if the industrial facility is a refinery, the input data may include quantities of crude oil input to the facility and corresponding times of arrival for shipments of the crude oil. For other types of facilities, the input data may include quantities of other input materials and corresponding delivery times.

In some embodiments, the output data may include quantities of output products and target delivery times for the output products. For example, if the industrial facility is a refinery, the output data may include quantities of refined oil products produced by the facility and corresponding target delivery times for the products. For other types of facilities, the output data may include quantities of other products produced by the facility.

The operational constraints may correspond to capabilities and limitations of the facility. For example, such operational constraints may include a maximum quantity of input resources that the industrial facility is capable of processing, a maximum speed of processing input resources by the industrial facility, a maximum quantity of output products that the industrial facility is capable of storing, a maximum power consumable at any given time to operate equipment, a maximum temperature of the facility, or any other capability and/or limitation that of the facility that may impact operations.

Scheduling applications 610 may interface with adaptors 612 and 614. Adaptors 612 and 614 may be network adaptors, for example, and may allow scheduling applications 610 to communicate with quantum optimization system 620. Quantum optimization system 620 may be similar to quantum optimization system 110 as described herein previously. In some embodiments, scheduling applications 610 may transmit operations data to quantum optimization system 620 via adaptors 612 and/or 614. Quantum optimization system 620 may include similar adaptors 622 and 629 configured to communicate with scheduling applications 610 and/or other network devices. In some embodiments, quantum optimization system 620 may receive operations data from scheduling applications 610 via adaptors 622 and/or 629.

When quantum optimization system 620 ingests operations data from scheduling applications 610 for an industrial facility, quantum optimization system 620 may perform optimization problem formulation 624. Optimization problem formulation 624 may be performed by, for example, formulation module 112 as described previously. In some embodiments, quantum optimization system 620 may generate an optimization model based on the set of operations data. The optimization model may define a plurality of variables corresponding to the operations facility to be solved for. The plurality of variables may include time-based variables. For example, in the case of a refinery, the plurality of variables may include times and durations of the various process steps described herein previously, such as crude blending, distillation, reforming, isomerization, or the like. The plurality of variables may further include a selection of facility components and/or equipment used for the various process steps.

Following optimization problem formulation 624, quantum optimization system 620 may be configured to calculate solution values based using quantum computer 626 and the optimization model. Quantum computer 626 may be included within calculation module 114, for example, and may include one or more quantum processors. Each of the solution values calculated by quantum computer 626 may correspond to the variables defined by the optimization model. For example, if a variable corresponds to a time for performing blending, the solution value may specify the exact start time and/or duration of the blending. The solution values may be optimized to minimize waste and/or penalties assessed against the facility.

Following calculation of the solution values, quantum optimization system 620 may perform quantum results interpretation 628. Quantum results interpretation 628 may involve transforming data generated by quantum computer 626 to be generally useable by a computer with traditional processing capabilities. In some embodiments, quantum results interpretation 628 may include transforming the data into a form that is readily understandable by human readers. Following quantum results interpretation 628, quantum optimization system 620 may transmit the resulting data to scheduling applications 610 via adaptors 622 and/or 629.

The resulting data, including the solution values, may be ingested by scheduling applications 610 via adaptors 612 and/or 614. Scheduling applications 610 may then generate process schedules for respective industrial facilities using the data and/or solution values received from quantum optimization system 620.

Hereinafter, methods of optimizing scheduling using quantum processing are described. It should be understood that in various embodiments, various components or combinations of components of the systems discussed previously may execute instructions or perform acts including the acts discussed below. Further, it should be understood that in various embodiments, various steps may be added, omitted, and/or rearranged in any suitable manner.

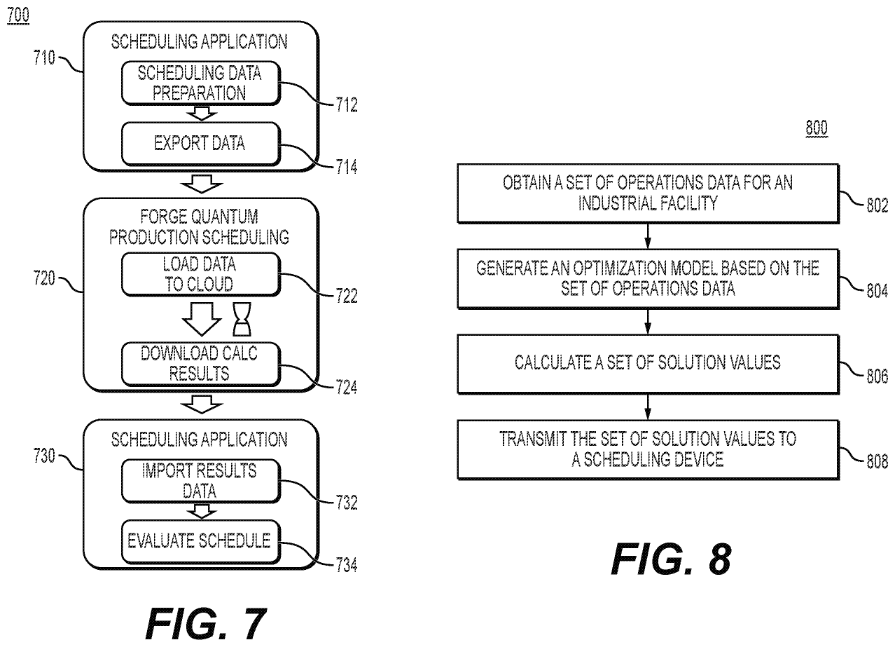

FIG. 7 depicts an exemplary method 700 of using a scheduling device in conjunction with a quantum optimization system. Method 700 may be performed, for example, using scheduling device 105, as described herein previously with reference to FIG. 1. Scheduling devices 105 may work in conjunction with quantum optimization system 110, as described with reference to FIG. 1, and/or quantum optimization system 620, as described with reference to FIG. 6. It should be understood that the method 700 may include fewer than all steps shown in FIG. 7 or may alternatively include additional steps not shown in FIG. 7.

At step 712, a scheduling application 710 running on a scheduling device may prepare data relating to a corresponding facility for analysis. Scheduling application 710 may be running on scheduling device 105, for example. The data relating to a corresponding facility may include operations data, as described herein previously. For example, the operations data may further include input data, output data, and/or operational constraints. The input data may include quantities of input resources and times of arrival to the industrial facility for the input resources. The output data may include quantities of output products and target delivery times for the output products. The operational constraints may correspond to capabilities and limitations of the facility.

At step 714, scheduling application 710 may export the data to a quantum interface application 720. In some embodiments, quantum interface application 720 may be running on the same scheduling device as scheduling application 710. In some embodiments, quantum interface application 720 may be running on another networked device Quantum interface application 720 may be configured to communicate with a remote quantum optimization system, such as quantum optimization system 110 and/or quantum optimization system 620. In some embodiments, quantum interface application 720 may be a special purpose application designed specifically to allow scheduling application 710 to communicate with the remote quantum optimization system.

At step 722, quantum interface application 720 may load the prepared data to the cloud. In some embodiments, loading the prepared data to the cloud may include transmitting the data to a remote quantum optimization system. When the quantum optimization system receives the data, it may then perform optimization problem formulation, quantum calculations, and results interpretation, as described previously with reference to FIG. 6.

Following processing by the remote quantum optimization system, quantum interface application 720 may download calculation results at step 724 from the remote quantum optimization system.

At step 732, the calculation results may be imported by scheduling application 730 from quantum interface application 720. In some embodiments, scheduling application 730 may be the same as scheduling application 710. In some embodiments, scheduling application 730 may be a different application running on the same scheduling device 105 or a different device. For example, scheduling application 730 may be an application dedicated to receiving and using calculation results from quantum optimization system.

At step 734, scheduling application 730 may use the calculation results to evaluate or generate an optimized schedule for a respective industrial facility. The optimized schedule may be optimized to minimize waste by the facilitate, minimize financial penalties, maximize profitability, and/or improve like metrics.

It is to be understood that method 700 need not necessarily be performed in the exact order described herein and the steps described herein may be rearranged in some embodiments. Further, in some embodiments fewer than all steps of method 700 may be performed and in some embodiments additional steps may be performed.

FIG. 8 depicts an exemplary method 800 of optimizing scheduling from the perspective of a quantum optimization system. The quantum optimization system may be quantum optimization system 110, as described previously with reference to FIG. 1, and/or quantum optimization system 620, as described herein previously with reference to FIG. 6. The quantum optimization system may include one or more quantum processors for performing calculations. It should be understood that the method 800 may include fewer than all steps shown in FIG. 8 or may alternatively include additional steps not shown in FIG. 8.

At step 802, the quantum optimization system may obtain a set of operations data for an industrial facility. The quantum optimization system may receive the set of operations data, for example, from a schedule device 105 for a corresponding facility 120. The scheduling devices 105 may be remote from the quantum optimization system, which may receive the operations data via a network. The operations data may include input data, output data, and/or operational constraints. The input data may include quantities of input resources and times of arrival to the industrial facility for the input resources. The output data may include quantities of output products and target delivery times for the output products. The operational constraints may correspond to capabilities and limitations of the facility.

At step 804, the quantum optimization system may generate an optimization model. The system may generate the optimization model based on the set of operations data. For example, the optimization model may be generated as part of optimization problem formulation 624, as described herein previously. The optimization model may define a plurality of variables corresponding to the facility to be solved for. In some embodiments, the plurality of variables may include time-based variables. In some embodiments, the plurality of variables may further include a selection of facility components and/or equipment used for the various process steps.

At step 806, the quantum optimization system may calculate a set of solution values for the variables. The system may calculate the set of solution values using the one or more quantum processors and the optimization model. In calculating the set of solution values, the one or more quantum processors may be used, for example, to factor in some, substantially all, or all of the large amount of operations data into the calculations. Performing such calculations using such a quantity of data may be impractical and/or take an unreasonably long period of time using traditional computer processing. With the one or more quantum processors, however, such calculations may be performed practically and within a commercially feasible period of time.

At step 808, the quantum optimization system may transmit the set of solution values to a remote scheduling device, such as scheduling device 105. In some embodiments, the quantum optimization system may transmit the solution values via network. The remote scheduling device may then use the solution values to generate a schedule for the industrial facility. As described with reference to FIG. 7, the remote scheduling device may receive the solution values from the quantum optimization system via quantum interface application 720, for example, and then use scheduling application 730 to generate the schedule.

It is to be understood that method 800 need not necessarily be performed in the exact order described herein and the steps described herein may be rearranged in some embodiments. Further, in some embodiments fewer than all steps of method 800 may be performed and in some embodiments additional steps may be performed.

Methods 700 and/or 800 as described herein may allow for improved optimization of scheduling for industrial facilities with efficient use of quantum resources. Specifically, by allowing remote scheduling devices via scheduling applications to communicate with a centralized quantum optimum system, quantum processing resources may be distributed to numerous clients without the need for individual clients to procure a dedicated quantum system at great expense. In effect, such a system may benefit multiple industrial facilities. Further, such configuration may be suitable for use in a Quantum as a Service (QaaS) format.

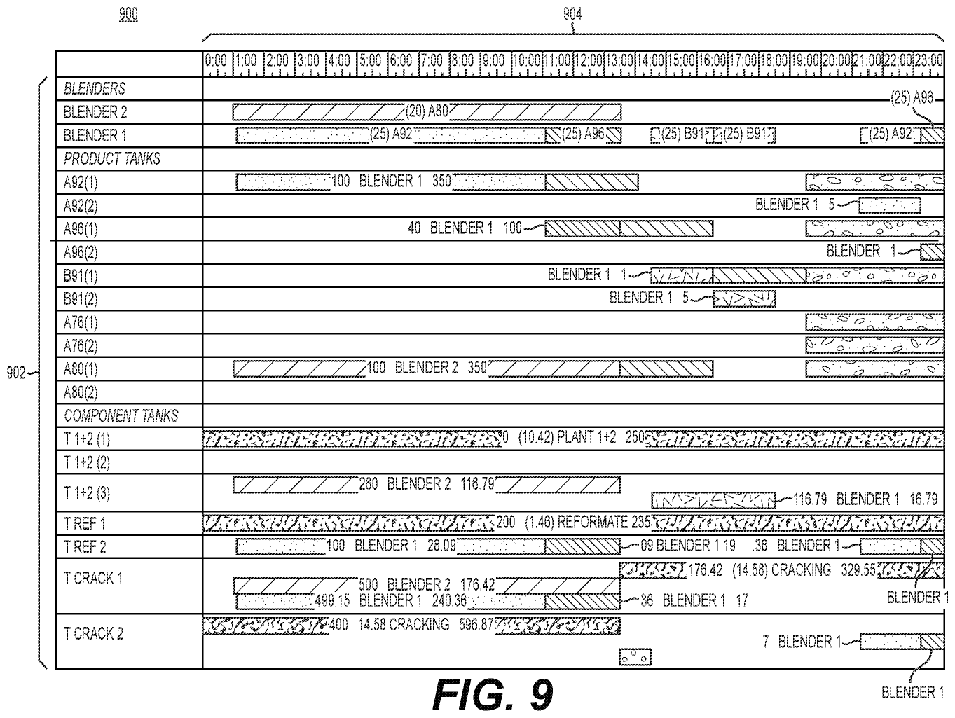

FIG. 9 depicts an exemplary schedule 900 for a refinery that may be generated using quantum optimization and demonstrates improvements relative to schedule 500. Like schedule 500, schedule 900 may include rows 902, wherein each row is indicative of a component of the refinery. Schedule 900 may further include time axis 904. By cross-referencing an item in schedule 900 to rows 902 and time axis 904, one may understand a scheduled time and duration for a given component. As with schedule 500, a constraint of the refinery represented by schedule 900 may be that product should be blended and certified by 19:00 to be delivered to customers on time. If product is not delivered to customers on time, contractual penalties may apply and consequently the refinery may suffer financial loss.

As shown in schedule 900, blender 1 may be scheduled to blend product A96 from 11:00 to 13:00. As a result, product A96 may be certified by 16:00, which is well in advance of the 19:00 deadline. Accordingly, a penalty and financial loss may be avoided. Similarly, blender 1 may be scheduled to blend product B91 from 14:00 to 18:00. As a result, product 91 may be certified by 19:00, thereby avoiding waste of the product. As demonstrated by FIG. 9, optimization of a facility schedule using quantum processing may lead to more efficient use of facility resources and improved financial performance of the facility.

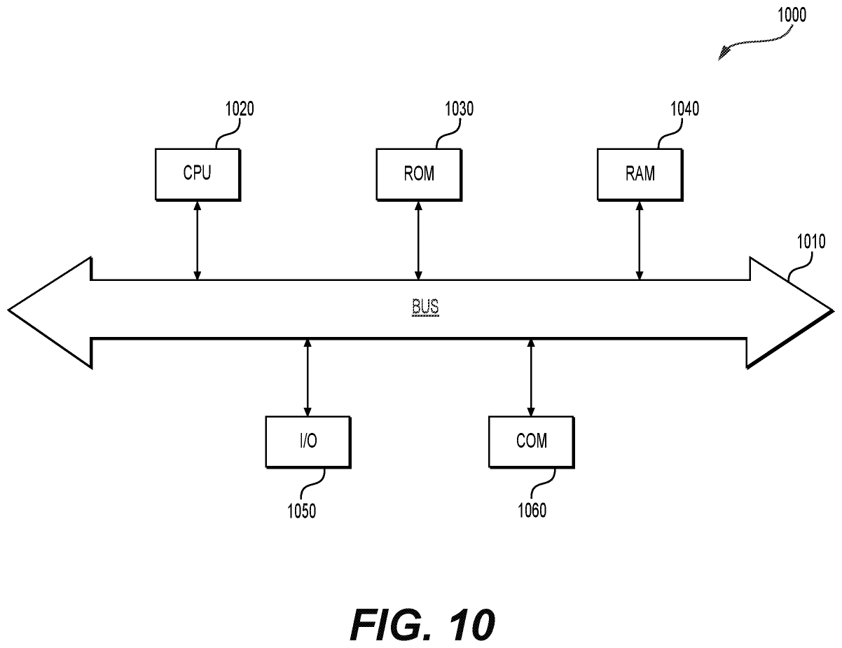

FIG. 10 depicts an example system that may execute techniques presented herein. FIG. 10 is a simplified functional block diagram of a computer that may be configured to execute techniques described herein, according to exemplary embodiments of the present disclosure. Specifically, the computer (or “platform” as it may not be a single physical computer infrastructure) may include a data communication interface 1060 for packet data communication. The platform may also include a central processing unit (“CPU”) 1020, in the form of one or more processors, for executing program instructions. The platform may include an internal communication bus 1010, and the platform may also include a program storage and/or a data storage for various data files to be processed and/or communicated by the platform such as ROM 1030 and RAM 1040, although the system 1000 may receive programming and data via network communications. The system 1000 also may include input and output ports 1050 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems and/or methods may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the internet or various other telecommunication networks. Such communications, for example, may enable loading of the software from one computer or processor into another, for example, from a management server or host computer of a mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, “one or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.”

The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication.

The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. A controller may be implemented in hardware or a combination of hardware and software/firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Other embodiments of the disclosure will be apparent to those skilled in the art from consideration of the specification and practice of the embodiments disclosed herein. It is intended that the specification and examples be considered as exemplary only, with a true scope and spirit of the present disclosure being indicated by the following claims.

What is claimed is:

1. A computer-implemented method of process control, comprising:
obtaining, by a device including at least one quantum processing unit, a set of operations data for an industrial facility, the set of operations data including (1) input data for the industrial facility, (2) output data for the industrial facility, and (3) a plurality of operational constraints for the industrial facility;
generating, by the device, an optimization model based on the set of operations data, wherein the optimization model defines a plurality of variables corresponding to operations of the industrial facility and wherein the plurality of variables includes one or more time-based variables;
calculating, by the device using the at least one quantum processing unit and the optimization model, a set of solution values, wherein each of the set of solution values corresponds to one or more of the plurality of variables and wherein the set of solution values includes one or more combinations of time and duration data; and
transmitting the set of solution values to a scheduling device configured to generate a process schedule for the industrial facility.

2. The computer-implemented method of claim 1, wherein the set of operations data for the industrial facility is obtained from the scheduling device.

3. The computer-implemented method of claim 1, wherein the input data includes one or more quantities of input resources and one or more times of arrival to the industrial facility for the input resources; and
wherein the output data includes one or more quantities of output products and one or more target delivery times for the output products.

4. The computer-implemented method of claim 3, wherein the operational constraints include constraints corresponding to one or more of a maximum quantity of input resources that the industrial facility is capable of processing, a maximum speed of processing input resources by the industrial facility, and a maximum quantity of output products that the industrial facility is capable of storing.

5. The computer-implemented method of claim 3, wherein the set of solution values includes start time information and duration information for each of a plurality of processing tasks.

6. The computer-implemented method of claim 5, wherein the set of solution values, when used to generate the process schedule, are configured to cause the industrial facility to yield the one or more quantities of output products by the one or more target delivery times.

7. The computer-implemented method of claim 6, wherein the industrial facility is an oil refinery, the input resources include crude oil, and the output products include refined oil products.

8. A non-transitory computer-readable storage medium storing program instructions that are computer-executable to implement operations comprising:
obtaining, by a device including at least one quantum processing unit, a set of operations data for an industrial facility, the set of operations data including (1) input data for the industrial facility, (2) output data for the industrial facility, and (3) a plurality of operational constraints for the industrial facility;
generating, by the device, an optimization model based on the set of operations data, wherein the optimization model defines a plurality of variables corresponding to operations of the industrial facility and wherein the plurality of variables includes one or more time-based variables;
calculating, by the device using the at least one quantum processing unit and the optimization model, a set of solution values, wherein each of the set of solution values corresponds to one or more of the plurality of variables and wherein the set of solution values includes one or more combinations of time and duration data; and
transmitting the set of solution values to a scheduling device configured to generate a process schedule for the industrial facility.

9. The non-transitory computer-readable storage medium of claim 8, wherein the set of operations data for the industrial facility is obtained from the scheduling device.

10. The non-transitory computer-readable storage medium of claim 8, wherein the input data includes one or more quantities of input resources and one or more times of arrival to the industrial facility for the input resources; and
wherein the output data includes one or more quantities of output products and one or more target delivery times for the output products.

11. The non-transitory computer-readable storage medium of claim 10, wherein the operational constraints include constraints corresponding to one or more of a maximum quantity of input resources that the industrial facility is capable of processing, a maximum speed of processing input resources by the industrial facility, and a maximum quantity of output products that the industrial facility is capable of storing.

12. The non-transitory computer-readable storage medium of claim 10, wherein the set of solution values includes start time information and duration information for each of a plurality of processing tasks.

13. The non-transitory computer-readable storage medium of claim 12, wherein the set of solution values, when used to generate the process schedule, are configured to cause the industrial facility to yield the one or more quantities of output products by the one or more target delivery times.

14. The non-transitory computer-readable storage medium of claim 13, wherein the industrial facility is an oil refinery, the input resources include crude oil, and the output products include refined oil products.

15. A system comprising:
one or more quantum processing units;
one or more memories storing instructions; and
one or more processors operatively connected to the one or more memories, the one or more processors configured to execute the instructions to:
obtain a set of operations data for an industrial facility, the set of operations data including (1) input data for the industrial facility, (2) output data for the industrial facility, and (3) a plurality of operational constraints for the industrial facility;
generate an optimization model based on the set of operations data, wherein the optimization model defines a plurality of variables corresponding to operations of the industrial facility and wherein the plurality of variables includes one or more time-based variables;
cause the one or more quantum processing units to calculate, using the optimization model, a set of solution values, wherein each of the set of solution values corresponds to one or more of the plurality of variables and wherein the set of solution values includes one or more combinations of time and duration data; and
transmit the set of solution values to a scheduling device configured to generate a process schedule for the industrial facility.

16. The system of claim 15, wherein the set of operations data for the industrial facility is obtained from the scheduling device.

17. The system of claim 15, wherein the input data includes one or more quantities of input resources and one or more times of arrival to the industrial facility for the input resources; and
wherein the output data includes one or more quantities of output products and one or more target delivery times for the output products.

18. The system of claim 17, wherein the operational constraints include constraints corresponding to one or more of a maximum quantity of input resources that the industrial facility is capable of processing, a maximum speed of processing input resources by the industrial facility, and a maximum quantity of output products that the industrial facility is capable of storing.

19. The system of claim 17, wherein the set of solution values includes start time information and duration information for each of a plurality of processing tasks.

20. The system of claim 19, wherein the set of solution values, when used to generate the process schedule, are configured to cause the industrial facility to yield the one or more quantities of output products by the one or more target delivery times.
